(19) United States
(12) Patent Application Publication
(10) Pub. No.: US 2025/0161952 A1
(43) Pub. Date: May 22, 2025

(54) SHREDDER

(71) Applicant: SEIKO EPSON CORPORATION, Tokyo (JP)

(72) Inventor: Takaya FUKUI, Matsumoto (JP)

(21) Appl. No.: 18/950,251

(22) Filed: Nov. 18, 2024

(30) Foreign Application Priority Data
Nov. 20, 2023 (JP) 2023-196474

(51) Int. Cl. B02C 18/00

(52) U.S. Cl. CPC B02C 18/0007; B02C 2018/0046; B02C 2201/00

(57) ABSTRACT

A shredder includes a shredding section that shreds paper into paper pieces, a housing section that houses the paper pieces, a bulk height sensor that detects the bulk height of the paper pieces housed in the housing section, a weight sensor that detects the weight of the paper pieces housed in the housing section, and a processor that prohibits shredding by the shredding section in response to indicating fullness of the housing section by either the bulk height detected or the weight detected.

The present application is based on, and claims priority from JP Application Serial Number 2023-196474, filed Nov. 20, 2023, the disclosure of which is hereby incorporated by reference herein in its entirety.

### BACKGROUND

### 1. Technical Field

The present disclosure relates to a shredder.

### 2. Related Art

A shredder having a shredded waste fullness

detector is known. A shredder described in JP-A-2014-240039 includes a shredding mechanism section, a shredded waste housing box, and a shredded waste detection device. The shredding mechanism section shreds supplied waste paper.

The shredded waste housing box houses waste shredded by the shredding mechanism section. The shredded waste detection device is disposed near a top opening surface of the shredded waste housing box. The shredded waste detection device is formed of an optical sensor. The shredded waste detection device detects that the shredded waste housing box has become full of shredded waste. The shredded waste detection device detects the bulk height of the shredded waste housed in the shredded waste housing box.

Even when the housing section is full, the optical sensor fails to detect the fullness in some cases.

### SUMMARY

A shredder of the present disclosure includes a shredding section that shreds paper into paper pieces, a housing section that houses the paper pieces, a bulk height measurement section that detects the bulk height of the paper pieces housed in the housing section, and a weight measurement section that detects the weight of the paper pieces housed in the housing section.

### BRIEF DESCRIPTION OF THE DRAWINGS

FIG. 1 is a diagram illustrating an external configuration of a shredding apparatus.

FIG. 2 is a diagram illustrating the external configuration of the shredding apparatus.

FIG. 3 is a diagram illustrating a schematic configuration of the shredding apparatus.

FIG. 4 is a diagram illustrating the schematic configuration of the shredding apparatus.

FIG. 5 is a diagram illustrating the schematic configuration of the shredding apparatus.

FIG. 6 is a diagram illustrating a block configuration of the shredding apparatus.

FIG. 7 is a flowchart illustrating an operation flow of the shredding apparatus.

FIG. 8 is a flowchart illustrating an operation flow of the shredding apparatus.

### DESCRIPTION OF EMBODIMENTS

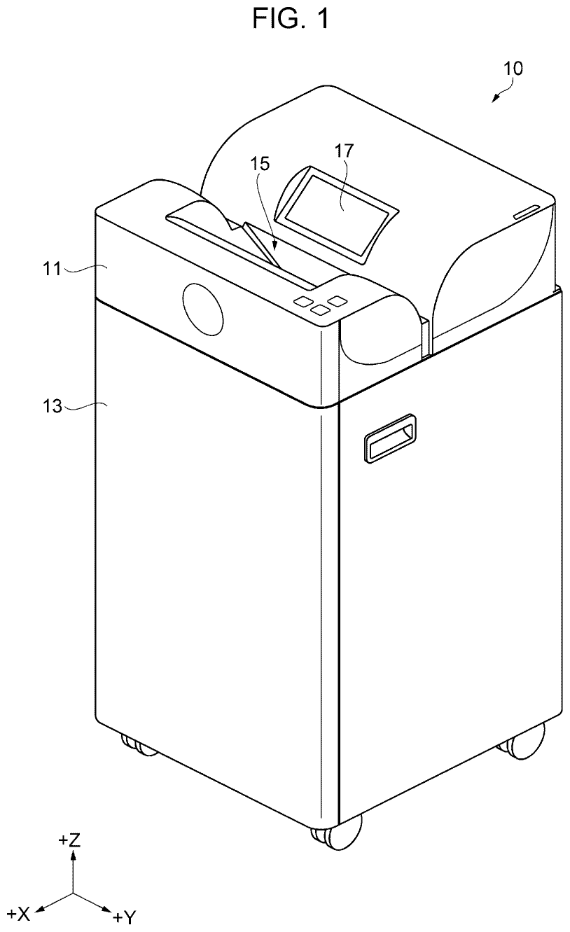

FIG. 1 illustrates an external configuration of a

shredding apparatus 10. FIG. 1 is a perspective view of the shredding apparatus 10. The shredding apparatus 10 generates paper pieces by shredding paper such as used paper. The paper pieces are used as raw material for a sheet manufacturing apparatus that recycles the paper pieces. The shredding apparatus 10 corresponds to one example of a shredder. The shredding apparatus 10 includes an exterior casing 11, an opening/closing door 13, a paper feed port 15, and a display unit 17.

In the drawings including FIG. 1, an XYZ coordinate

system is illustrated. A Z-axis is an axis perpendicular to the installation surface of the shredding apparatus 10. A +Z direction is a direction from the installation surface toward the upper side. A −Z direction is a direction from the upper side toward the installation surface. An X-axis is an axis parallel to the installation surface. The X-axis is an axis that couples the front surface to the back surface. The front surface of the shredding apparatus 10 is a surface opposite a user of the shredding apparatus 10 when the user is located at a position opposite the display unit 17. The back surface is an opposite surface to the front surface. A +X direction is a direction from the back surface of the shredding apparatus 10 toward the front surface thereof. A −X direction is a direction from the front surface toward the back surface. A Y-axis is an axis parallel to the installation surface. The Y-axis is an axis orthogonal to the X-axis. A +Y direction is a direction from the left of the shredding apparatus 10 toward the right thereof in plan view from the front surface. A −Y direction is a direction from the right of the shredding apparatus 10 toward the left thereof in plan view from the front surface.

The exterior casing 11 is an exterior package that covers each unit of the shredding apparatus 10. The opening/closing door 13, the paper feed port 15, and the display unit 17 are disposed in the exterior casing 11.

Although the exterior casing 11 illustrated in FIG. 1 has a rectangular parallelepiped shape, the shape of the exterior casing 11 is not limited thereto. The shape of the exterior casing 11 is set as appropriate.

The opening/closing door 13 is disposed in the exterior casing 11. The opening/closing door 13 is configured to be openable and closable. The opening/closing door 13 pivots around a pivot axis along the Z-axis. The opening/closing door 13 is opened and closed by a user.

When the user opens the opening/closing door 13, each unit disposed inside the exterior casing 11 becomes accessible by the user.

The paper feed port 15 is an opening through which paper such as used paper is charged. The paper feed port 15 is made in the surface of the exterior casing 11 on the +Z direction side. Paper is supplied to a shredding unit 21 to be described later through the paper feed port 15. The paper feed port 15 is configured to allow sheets of paper to be collectively supplied.

The display unit 17 displays various kinds of

information. The display unit 17 displays error information relating to fullness, excessive temperature rise, and the like as one example. The display unit 17 may display the processing amount of paper processed by the shredding apparatus 10. The display unit 17 is formed of a liquid crystal panel, an organic electroluminescence (EL) panel, or the like.

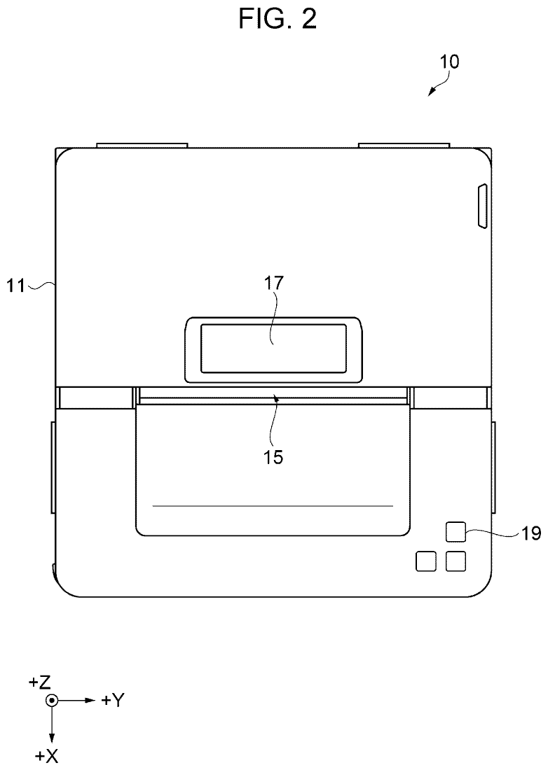

FIG. 2 illustrates the external configuration of the shredding apparatus 10. FIG. 2 illustrates the shredding apparatus 10 in plan view from the +Z direction side. The display unit 17 and an operation button 19 are disposed in the surface of the shredding apparatus 10 on the +Z direction side. The shredding apparatus 10 illustrated in FIG. 2 includes a plurality of operation buttons 19.

The operation buttons 19 are operated by a user. The operation buttons 19 include a power button to switch on or off a power supply to the shredding apparatus 10. The operation buttons 19 may include a rotation direction instruction button to cause forward rotation or reverse rotation of the shredding unit 21. The operation buttons 19 may include a stop instruction button to stop the shredding unit 21. Although the shredding apparatus 10 illustrated in FIG. 2 includes two or more operation buttons 19, the number of buttons of the shredding apparatus 10 is not limited thereto. The shredding apparatus 10 may include one operation button 19.

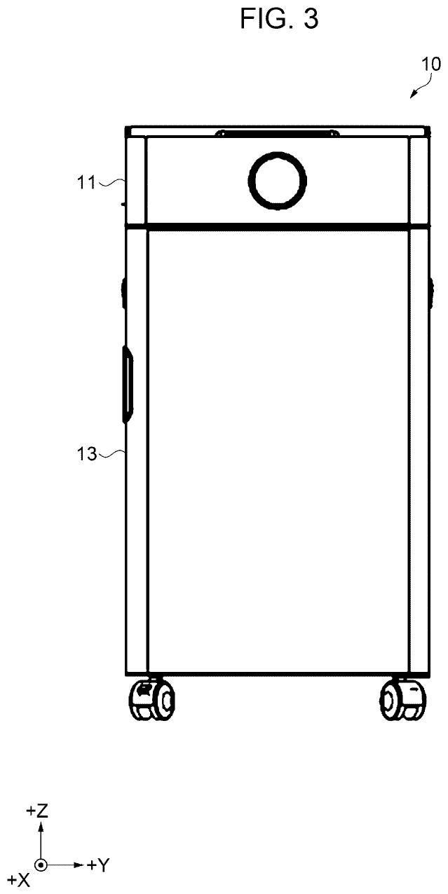

FIG. 3 illustrates a schematic configuration of the shredding apparatus 10. FIG. 3 illustrates the shredding apparatus 10 in plan view from the +X direction side. FIG. 3 illustrates the shredding apparatus 10 in the state in which the opening/closing door 13 is closed.

In the state in which the opening/closing door 13 is closed, the user is unable to access each unit housed in the exterior casing 11. In the state in which the opening/closing door 13 is closed, the shredding apparatus 10 is allowed to shred paper. The shredding apparatus 10 may include an opening/closing sensor that detects opening and closing of the opening/closing door 13. The shredding apparatus 10 can detect opening and closing of the opening/closing door 13 by an output result by the opening/closing sensor.

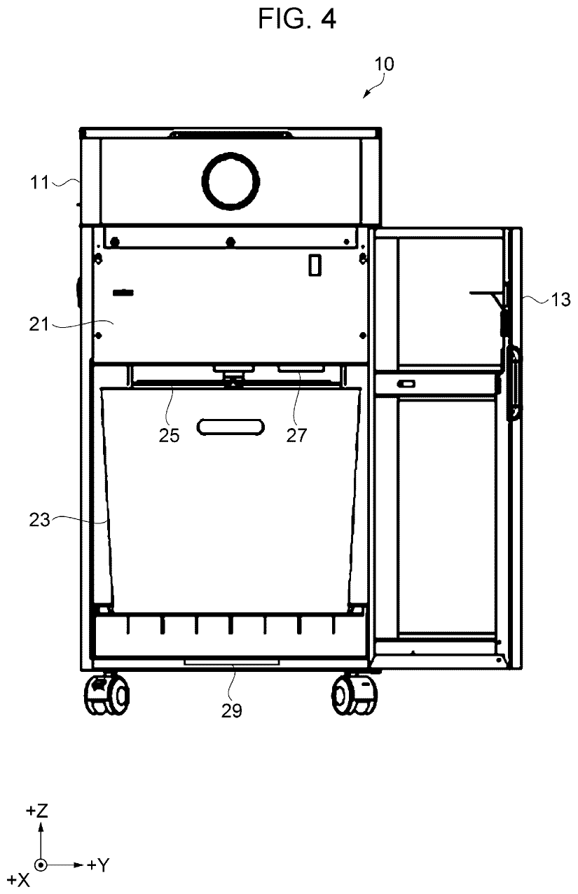

FIG. 4 illustrates the schematic configuration of the shredding apparatus 10. FIG. 4 illustrates the shredding apparatus 10 in plan view from the +X direction side. FIG. 4 illustrates the shredding apparatus 10 in the state in which the opening/closing door 13 is opened. FIG. 4 illustrates each unit housed inside the exterior casing 11. The exterior casing 11 houses the shredding unit 21, a housing box 23, a leveling component 25, an optical sensor 27, and a weight sensor 29.

The shredding unit 21 shreds paper into paper pieces. The shredding unit 21 has a plurality of cutters, a shredding unit drive mechanism 31 to be described later, and so forth. The cutters are not illustrated. The shredding unit 21 has a pair of cylindrical cutters as one example. Blades are formed on the outer circumferential surface of each of the pair of cylindrical cutters. The blades formed on the outer circumferential surfaces of the respective cylindrical cutters mesh with each other and rotate. The pair of cylindrical cutters rotate by the shredding unit drive mechanism 31. Paper charged from the paper feed port 15 is shredded by the pair of cylindrical cutters. The shredding unit 21 may have a cross cutter that cuts paper in a direction intersecting the rotation axis of the cylindrical cutters. The configuration of the shredding unit 21 is not limited as long as it is a configuration that shreds paper. The configuration of the shredding unit 21 can be set as appropriate. The shredding unit 21 corresponds to one example of the shredding section.

The shredding unit 21 has a shredding unit opening 21a. The shredding unit 21 discharges paper pieces from the shredding unit opening 21a. The shredding unit opening 21a will be described later. The paper pieces fall in the-Z direction from the shredding unit opening 21a.

The housing box 23 houses paper pieces generated by shredding of paper by the shredding unit 21. The housing box 23 is formed of a hollow container. The housing box 23 is disposed at a position on the-Z direction side of the shredding unit 21 in the exterior casing 11. The housing box 23 becomes accessible by the user when the opening/closing door 13 is opened. The housing box 23 is configured to be allowed to be taken out from the exterior casing 11 by the user. The housing box 23 corresponds to one example of the housing section.

The leveling component 25 levels the upper surface of the paper pieces housed in the housing box 23. The leveling component 25 is disposed at a position on the-Z direction side of the shredding unit 21. The leveling component 25 is driven by a leveling component drive mechanism 33 to be described later. Although the shredding apparatus 10 illustrated in FIG. 4 includes the leveling component 25, the configuration of the shredding apparatus 10 is not limited thereto. The shredding apparatus 10 may or may not include the leveling component 25. It is preferable for the shredding apparatus 10 to include the leveling component 25. Inclusion of the leveling component 25 allows effective use of the capacity of the housing box 23.

The optical sensor 27 detects the bulk height of paper pieces housed in the housing box 23. The optical sensor 27 illustrated in FIG. 4 is disposed at a position on the +Z direction side of the housing box 23. The optical sensor 27 is formed of a reflective sensor as one example. The reflective sensor detects reflected light of emitted light. The reflective sensor detects the bulk height of the paper pieces housed in the housing box 23 by detecting the upper surface position of the paper pieces along the Z-axis. Detecting the bulk height of the paper pieces by the optical sensor 27 allows the shredding apparatus 10 to detect whether or not the housing box 23 is full. The optical sensor 27 corresponds to one example of the bulk height measurement section. The detection system and the disposing position of the sensor of the bulk height measurement section are not limited as long as the sensor of the bulk height measurement section is capable of detecting the bulk height of the paper pieces housed in the housing box 23. An ultrasonic system, a mechanical system using a lever, and the like are conceivable as detection systems other than the optical system.

The weight sensor 29 detects the weight of the paper pieces housed in the housing box 23. The weight sensor 29 measures the weight of the paper pieces housed in the housing box 23 by measuring the weight of the housing box 23. Detecting the weight of the paper pieces by the weight sensor 29 allows the shredding apparatus 10 to detect whether or not the housing box 23 is full. The weight sensor 29 is disposed at a position on the −-Z direction side of the housing box 23. The weight sensor 29 corresponds to one example of the weight measurement section. The disposing position of the weight sensor 29 is not limited as long as the weight sensor 29 is capable of detecting the weight of the paper pieces in the housing box 23. For example, the weight sensor 29 may be disposed at a position at which the weight sensor 29 supports the housing box 23 from the lower side, or be disposed at a position at which the weight sensor 29 hangs the housing box 23 from the upper side.

The shredding apparatus 10 can collectively shred a predetermined number of paper sheets. When the number of paper sheets shredded by the shredding apparatus 10 at one time increases, the bulk density of paper pieces discharged from the shredding unit 21 becomes higher. When the number of paper sheets charged from the paper feed port 15 at one time by a user is large, the paper pieces housed in the housing box 23 are compressed at once.

The user can take out the housing box 23 from the exterior casing 11.

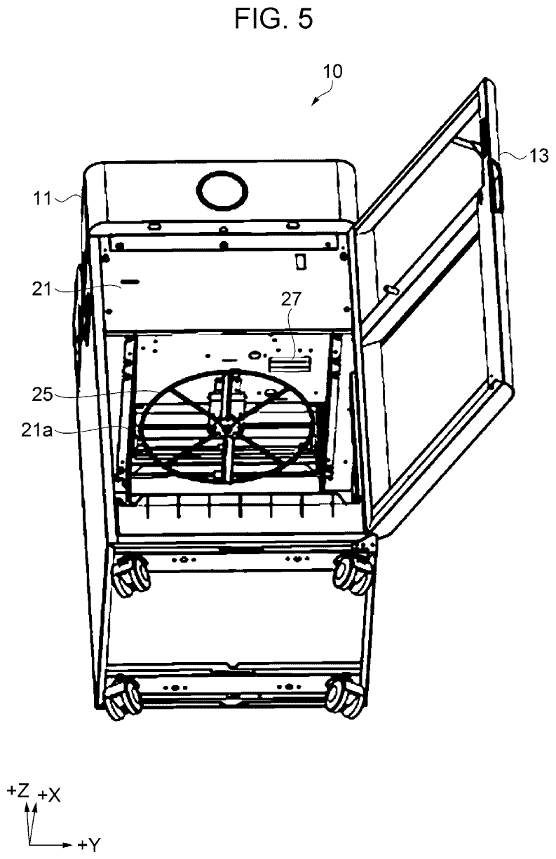

FIG. 5 illustrates the schematic configuration of the shredding apparatus 10. FIG. 5 is a perspective view of the shredding apparatus 10 as viewed from the +X direction side and the-Z direction side. FIG. 5 illustrates the shredding apparatus 10 in the state in which the opening/closing door 13 is opened. FIG. 5 illustrates the state in which the housing box 23 has been removed. FIG. 5 illustrates the shredding apparatus 10 in such a manner that the surface of the shredding unit 21 on the-Z direction side is visible. The shredding unit opening 21a, the leveling component 25, and the optical sensor 27 are disposed in and on the surface of the shredding unit 21 on the −Z direction side.

The shredding unit opening 21a discharges paper pieces from the shredding unit 21. The shredding unit opening 21a is made at part of the surface of the shredding unit 21 on the −Z direction side. The paper pieces discharged from the shredding unit opening 21a freely fall into the housing box 23. The amount of paper pieces that fall to a position directly under the shredding unit opening 21a becomes larger than the amount of paper pieces that fall to a position different from the position directly under the shredding unit opening 21a. The height of the paper pieces housed in the housing box 23 varies depending on the positional relationship with the shredding unit opening 21a. The variation in the height of the paper pieces precludes effective use of the capacity of the housing box 23.

The leveling component 25 reduces the variation in the height of the paper pieces housed in the housing box 23. As one example, the leveling component 25 is composed of a ring member and a plurality of shafts that support the ring member as illustrated in FIG. 5. The leveling component 25 reduces the variation in the height of the paper pieces housed in the housing box 23 by rotating at a predetermined speed.

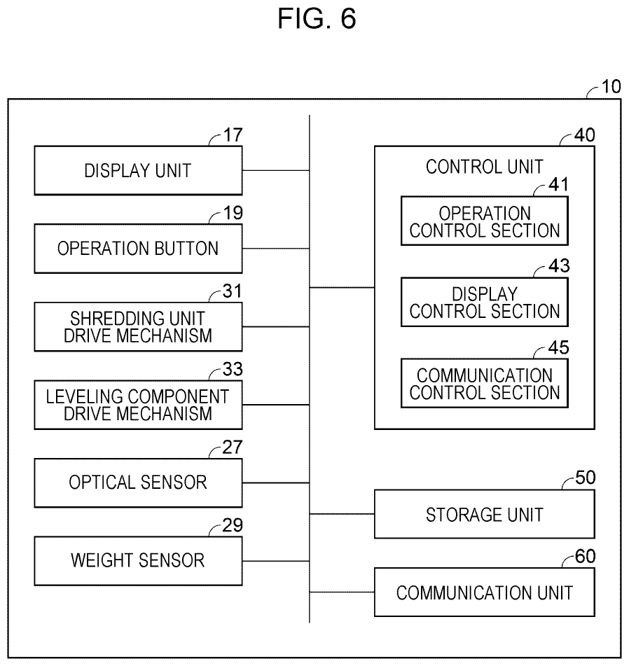

FIG. 6 illustrates the block configuration of the shredding apparatus 10. The shredding apparatus 10 includes the display unit 17, the operation buttons 19, the optical sensor 27, the weight sensor 29, the shredding unit drive mechanism 31, the leveling component drive mechanism 33, a control unit 40, a storage unit 50, and a communication unit 60.

The display unit 17 displays, based on control by the control unit 40, various kinds of information. The display unit 17 displays information based on height detection data detected by the optical sensor 27 and weight detection data detected by the weight sensor 29.

The operation buttons 19 output various operation signals. When a user executes operation to the operation button 19, the operation button 19 outputs the operation signal to the control unit 40. The control unit 40 controls, based on the operation signal, the display unit 17 and so forth. When the operation button 19 is a power button, the power button outputs a power-on signal or power-off signal. When receiving the power-on signal, the control unit 40 starts various kinds of control. When receiving the power-off signal, the control unit 40 stops each unit.

The optical sensor 27 executes, based on control by the control unit 40, height detection operation. The optical sensor 27 outputs the height detection data to the control unit 40. As one example, the height detection data is a height detection flag indicating that the bulk height of paper pieces has reached a reference bulk height that is set in advance. The height detection flag indicates that the housing box 23 is full. The optical sensor 27 outputs the height detection flag while the bulk height of the paper pieces reaches the reference bulk height. The optical sensor 27 stops the output of the height detection flag when detecting that the bulk height of the paper pieces is lower than the reference bulk height after outputting the height detection flag. The height detection data may be height value data indicating the bulk height of the paper pieces. The height detection data corresponds to one example of a bulk height detection result.

The weight sensor 29 executes, based on control by the control unit 40, weight detection operation. The weight sensor 29 outputs the weight detection data to the control unit 40. As one example, the weight detection data is a weight detection flag indicating that the weight of paper pieces has reached a reference weight that is set in advance. The weight detection flag indicates that the housing box 23 is full. The weight sensor 29 outputs the weight detection flag while the weight of the paper pieces reaches the reference weight. The weight sensor 29 stops the output of the weight detection flag when detecting that the weight of the paper pieces is lower than the reference weight after outputting the weight detection flag. The weight detection data may be weight value data indicating the weight of the paper pieces. The weight detection data corresponds to one example of a weight detection result.

The compression state of the paper pieces housed in the housing box 23 is adjusted within a predetermined range based on the reference bulk height and the reference weight. The paper pieces are used as raw material for a sheet manufacturing apparatus. When the compression state of the paper pieces varies, the thickness, the density per unit area, and the like vary regarding a sheet manufactured by the sheet manufacturing apparatus. When the compression state of the paper pieces varies, the quality of the sheet manufactured by the sheet manufacturing apparatus varies. The quality of the sheet generated by the sheet manufacturing apparatus is stabilized by use of the paper pieces generated by the shredding apparatus 10 including the optical sensor 27 and the weight sensor 29 as the raw material for the sheet manufacturing apparatus. The shredding apparatus 10 can provide the raw material for manufacturing the sheet with a stabled quality.

The shredding unit drive mechanism 31 drives the shredding unit 21. The shredding unit drive mechanism 31 drives, based on control by the control unit 40, the shredding unit 21. The shredding unit drive mechanism 31 has a shredding motor and a shredding motor driving transmission mechanism. The shredding motor generates a shredding driving force that drives cutters such as cylindrical cutters. The shredding motor driving transmission mechanism transmits the shredding driving force generated in the shredding motor to the cutters.

The leveling component drive mechanism 33 drives the leveling component 25. The leveling component drive mechanism 33 drives, based on control by the control unit 40, the leveling component 25. The leveling component drive mechanism 33 has a turning motor and a turning motor driving transmission mechanism. The turning motor generates a turning driving force that rotationally drives the leveling component 25. The turning motor driving transmission mechanism transmits the turning driving force generated in the turning motor to the leveling component 25.

The control unit 40 is a controller that controls the shredding apparatus 10. The control unit 40 is a processor having a central processing unit (CPU) as one example. The control unit 40 is configured by one or two or more processors. The control unit 40 operates as various functional sections by executing a control program. The control unit 40 functions as an operation control section 41, a display control section 43, and a communication control section 45 by executing the control program. The control unit 40 may function as a functional section other than the operation control section 41, the display control section 43, and the communication control section 45 by executing the control program.

The operation control section 41 controls operations of the shredding unit 21, the leveling component 25, the optical sensor 27, and the weight sensor 29. The operation control section 41 controls operation timing, stop timing, and the like of each of the shredding unit 21, the leveling component 25, the optical sensor 27, and the weight sensor 29. The operation control section 41 receives the height detection data output from the optical sensor 27 and the weight detection data output from the weight sensor 29. The operation control section 41 determines, based on the height detection data and the weight detection data, that the housing box 23 is full. The operation control section 41 corresponds to one example of a control section.

The operation control section 41 controls operation of the shredding unit 21 by driving the shredding unit drive mechanism 31. The operation control section 41 receives the height detection flag, which is one example of the height detection data, and the weight detection flag, which is one example of the weight detection data. The operation control section 41 controls the operation of the shredding unit 21, based on the height detection flag and the weight detection flag. The operation control section 41 receives at least one of the height detection flag and the weight detection flag when the shredding unit 21 is executing shredding operation. When receiving at least one of the height detection flag and the weight detection flag, the operation control section 41 determines that the housing box 23 is full. The operation control section 41 stops the shredding operation by the shredding unit 21. This prevents or reduces the occurrence of the situation in which the shredding operation is further executed in the state in which the housing box 23 is already full and paper pieces are compacted in the housing box 23 and are excessively compressed. The operation control section 41 does not operate the shredding unit 21 until the outputs of the height detection flag and the weight detection flag are stopped.

The operation control section 41 may receive the weight detection data when the shredding unit 21 is in the stopped state. When receiving the weight detection flag as one example of the weight detection data, the operation control section 41 determines that the housing box 23 is full. The operation control section 41 does not operate the shredding unit 21 until the output of the weight detection flag is stopped.

The operation control section 41 may receive the height value data at a predetermined time interval. The height value data is one example of the height detection data. The operation control section 41 compares the height value data with a height threshold. The height threshold is a value that is set in advance. The height threshold is stored in the storage unit 50 in advance. When the height value data is higher than the height threshold, the operation control section 41 determines that the housing box 23 is full. When the height value data is lower than the height threshold, the operation control section 41 determines that the housing box 23 is not full.

The operation control section 41 may receive the weight value data at a predetermined time interval. The weight value data is one example of the weight detection data. The operation control section 41 compares the weight value data with a weight threshold. The weight threshold is a value that is set in advance. The weight threshold is stored in the storage unit 50 in advance. When the weight value data is larger than the weight threshold, the operation control section 41 determines that the housing box 23 is full. When the weight value data is smaller than the weight threshold, the operation control section 41 determines that the housing box 23 is not full.

The operation control section 41 determines whether or not the housing box 23 is full, based on at least one of the height value data and the weight value data. The operation control section 41 continues the shredding operation by the shredding unit 21 when determining that the housing box 23 is not full when the shredding unit 21 is executing the shredding operation. The operation control section 41 stops the shredding operation by the shredding unit 21 when determining that the housing box 23 is full when the shredding unit 21 is executing the shredding operation. The operation control section 41 does not operate the shredding unit 21 until determining that the housing box 23 is not full.

The operation control section 41 may receive the weight value data as one example of the weight detection data when the shredding unit 21 is in the stopped state. When receiving the weight value data, the operation control section 41 determines whether or not the housing box 23 is full. The operation control section 41 does not operate the shredding unit 21 when determining that the housing box 23 is full.

The compression state of the paper pieces housed in the housing box 23 is adjusted within a predetermined range, based on the height threshold and the weight threshold. The paper pieces are used as raw material for the sheet manufacturing apparatus. When the compression state of the paper pieces varies, the thickness, the density per unit area, and the like vary regarding a sheet manufactured by the sheet manufacturing apparatus. When the compression state of the paper pieces varies, the quality of the sheet manufactured by the sheet manufacturing apparatus varies. The generation of the paper pieces by the shredding apparatus 10 including the optical sensor 27 and the weight sensor 29 stabilizes the quality of the sheet generated by using the paper pieces as the raw material. The shredding apparatus 10 can generate the raw material for manufacturing the sheet with a stabled quality.

The operation control section 41 controls operation of the leveling component 25 by driving the leveling component drive mechanism 33. The operation control section 41 may control the operation of the leveling component 25, based on at least one of the height detection data and the weight detection data. As one example, the operation control section 41 stops the operation of the leveling component 25 when receiving either the height detection flag or the weight detection flag.

The operation control section 41 controls the height detection operation by the optical sensor 27. The operation control section 41 causes the optical sensor 27 to execute the height detection operation when the shredding unit 21 is executing the shredding operation. The optical sensor 27 detects the bulk height of paper pieces. The operation control section 41 keeps the optical sensor 27 from executing the height detection operation when the shredding unit 21 is not executing the shredding operation. The optical sensor 27 does not detect the bulk height of the paper pieces.

The operation control section 41 controls the weight detection operation by the weight sensor 29. When the shredding unit 21 is executing the shredding operation, the operation control section 41 may cause the weight sensor 29 to execute the weight detection operation or keep the weight sensor 29 from executing the weight detection operation. It is preferable for the operation control section 41 to keep the weight sensor 29 from executing the weight detection operation when the shredding unit 21 is executing the shredding operation. Execution of the shredding operation by the shredding unit 21 causes vibrations. The detection value by the weight sensor 29 varies due to the vibrations in some cases. It is preferable for the operation control section 41 to cause the weight sensor 29 to execute the weight detection operation when the shredding unit 21 is not executing the shredding operation. The weight sensor 29 detects the weight of paper pieces.

The display control section 43 controls display by the display unit 17. The display control section 43 causes the display unit 17 to display various indications based on the height detection data detected by the optical sensor 27 or the weight detection data detected by the weight sensor 29. The display control section 43 causes the display unit 17 to display information indicating that the housing box 23 is full based on the height detection data as one example. The display control section 43 may cause the display unit 17 to display the information indicating that the housing box 23 is full based on the weight detection data. The display control section 43 may cause the display unit 17 to display error information or the like. The display control section 43 may cause the display unit 17 to display information based on data received through the communication unit 60.

The communication control section 45 controls various kinds of communication by the communication unit 60. The communication control section 45 transmits the weight detection data detected by the weight sensor 29 to an external apparatus through the communication unit 60. The communication control section 45 may transmit data based on the weight detection data detected by the weight sensor 29 to an external apparatus through the communication unit 60. The data based on the weight detection data is data indicating that the housing box 23 is full, data relating to the number of times the housing box 23 has become full, or the like. The communication control section 45 may transmit the height detection data detected by the optical sensor 27, data based on the height detection data, or the like to an external apparatus through the communication unit 60. The communication control section 45 causes the communication unit 60 to receive various data transmitted from an external apparatus. The communication control section 45 causes the various data transmitted from the external apparatus to be transmitted from the communication unit 60 to the operation control section 41, the display control section 43, and the like.

The storage unit 50 stores various programs, various data, and the like. The storage unit 50 stores the control program. The storage unit 50 may store the height threshold and the weight threshold. The storage unit 50 may store the height detection data and the weight detection data. The storage unit 50 is configured by a volatile semiconductor memory such as a random access memory (RAM), a non-volatile memory such as a read only memory (ROM) or flash memory, or the like.

The communication unit 60 is an interface circuit that communicates and connects with an external apparatus. The communication unit 60 connects to the external apparatus in a wired or wireless manner in accordance with a predetermined communication protocol. The communication unit 60 includes a wired connector, a wireless communication port, and the like. The communication unit 60 is a Universal Serial Bus (USB) connector, a local area network (LAN) connector, or the like. The wireless communication port is a Wi-Fi communication port, a Bluetooth communication port, or the like. Wi-Fi and Bluetooth are registered trademarks. The communication unit 60 receives various data from an external apparatus. The communication unit 60 transmits a processing result or the like by the shredding apparatus 10 to an external apparatus.

The shredding apparatus 10 includes the operation control section 41 that determines that the housing box 23 is full based on the height detection data detected by the optical sensor 27 and the weight detection data detected by the weight sensor 29.

Even when the shredding apparatus 10 does not notice fullness with only the optical sensor 27, the shredding apparatus 10 can determine that the housing box 23 is full based on the weight detection data detected by the weight sensor 29. The shredding apparatus 10 becomes capable of suppressing excessive compression of paper pieces.

The operation control section 41 controls operations of the shredding unit 21, the optical sensor 27, and the weight sensor 29.

The shredding apparatus 10 can cause the shredding unit 21, the optical sensor 27, and the weight sensor 29 to operate in association with each other.

The operation control section 41 does not operate the shredding unit 21 when determining that the housing box 23 is full.

The shredding apparatus 10 can suppress overflow of paper pieces generated by the shredding unit 21 from the housing box 23.

The operation control section 41 causes the optical sensor 27 to detect the bulk height of paper pieces when the shredding unit 21 is operating, and causes the weight sensor 29 to detect the weight of the paper pieces after the shredding unit 21 has stopped the operation.

By detecting the weight of the paper pieces when the shredding unit 21 is in the stopped state, the shredding apparatus 10 can improve the measurement accuracy of the weight of the paper pieces. Furthermore, because the optical sensor 27 detects the bulk height when the shredding unit 21 is operating, the shredding apparatus 10 can detect whether or not the housing box 23 is full during operation.

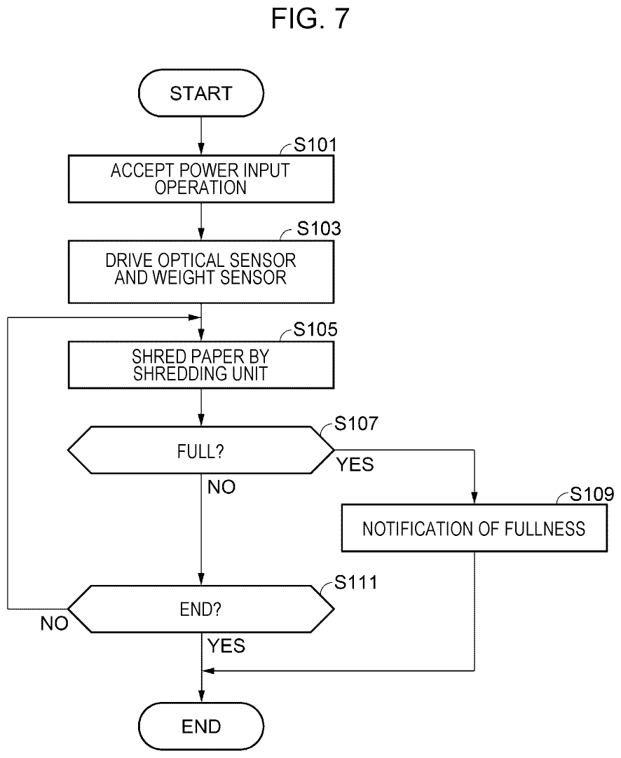

FIG. 7 illustrates an operation flow of the shredding apparatus 10. FIG. 7 illustrates one example of the operation flow of the shredding apparatus 10 by a flowchart. In the operation flow illustrated in FIG. 7, the optical sensor 27 and the weight sensor 29 execute detection operation during shredding operation by the shredding unit 21. The operation flow corresponds to one example of a control method.

The shredding apparatus 10 accepts power input operation in a step S101. A user executes an input operation to a power button included in the operation buttons 19. When the user has executed the input operation to the power button, the shredding apparatus 10 accepts the power input operation. The shredding apparatus 10 is in the state in which the shredding operation by the shredding unit 21 can be executed.

After accepting the power input operation, the shredding apparatus 10 drives the optical sensor 27 and the weight sensor 29 in a step S103. The operation control section 41 causes execution of the height detection operation by the optical sensor 27. The optical sensor 27 starts detection of the bulk height of paper pieces housed in the housing box 23. The operation control section 41 causes execution of the weight detection operation by the weight sensor 29. The weight sensor 29 starts detection of the weight of the paper pieces housed in the housing box 23.

After driving the optical sensor 27 and the weight sensor 29, the shredding apparatus 10 shreds paper by the shredding unit 21 in a step S105. When the user charges the paper from the paper feed port 15, the shredding unit 21 shreds the paper. The shredding unit 21 discharges paper pieces generated by shredding the paper from the shredding unit opening 21a. The paper pieces discharged are housed in the housing box 23. The optical sensor 27 detects the bulk height of the paper pieces housed in the housing box 23. The optical sensor 27 outputs the height detection data. The weight sensor 29 detects the weight of the paper pieces housed in the housing box 23. The weight sensor 29 outputs the weight detection data.

When the paper is being shredded by the shredding unit 21, the shredding apparatus 10 detects whether or not the housing box 23 is full in a step S107. The operation control section 41 detects whether or not the housing box 23 is full based on the height detection data output from the optical sensor 27 and the weight detection data output from the weight sensor 29. When the operation control section 41 determines that the housing box 23 is full, the shredding apparatus 10 advances to a step S109 (step S107: YES). When the operation control section 41 determines that the housing box 23 is not full, the shredding apparatus 10 advances to a step S111 (step S107: NO).

The shredding apparatus 10 gives a notification that the housing box 23 is full in the step S109. The display control section 43 transmits display data indicating that the housing box 23 is full to the display unit 17. The display control section 17 executes, based on the display data, display indicating that the housing box 23 is full. The operation control section 41 stops the shredding operation by the shredding unit 21. The shredding apparatus 10 may transmit the weight of the paper pieces housed in the housing box 23 to an external apparatus through the communication unit 60. The shredding apparatus 10 stops the shredding operation.

In the step S111, the shredding apparatus 10 determines whether or not the shredding operation has ended. As one example, the shredding apparatus 10 determines whether or not paper is being supplied from the paper feed port 15 by using a paper sensor not illustrated. The paper sensor detects whether or not paper is being supplied to the paper feed port 15. The paper sensor is formed of a weight detection lever or the like that detects whether or not paper exists. The shredding apparatus 10 may detect whether or not paper is being supplied from the paper feed port 15 by using a detection mechanism other than the paper sensor. The detection mechanism is set as appropriate. When detecting that paper is not being supplied from the paper feed port 15, the shredding apparatus 10 determines that the shredding operation has ended. The shredding apparatus 10 ends the shredding operation (step S111; YES). When detecting that paper is being supplied from the paper feed port 15, the shredding apparatus 10 determines that the shredding operation has not ended. The shredding apparatus 10 returns to the step S105 (step S111; NO).

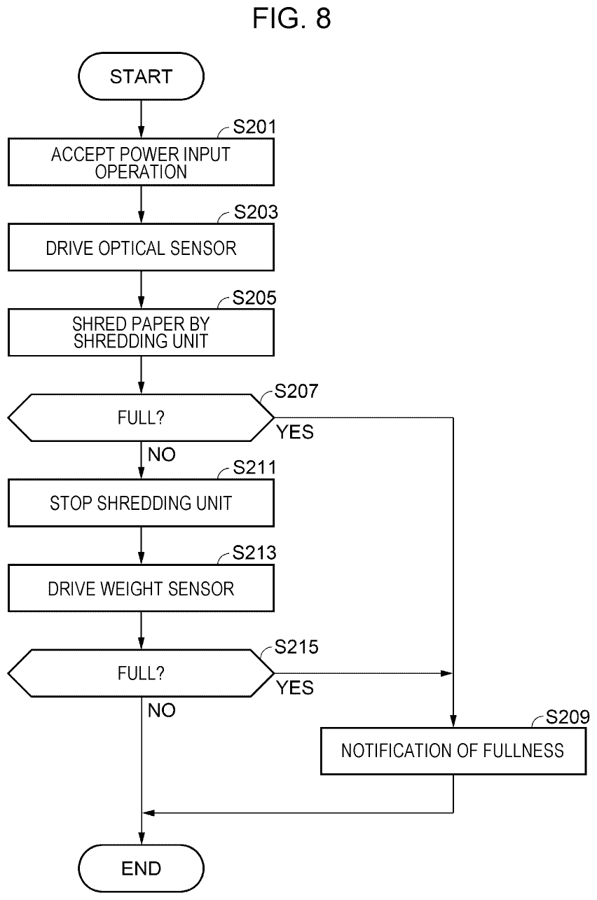

FIG. 8 illustrates an operation flow of the shredding apparatus 10. FIG. 8 illustrates one example of the operation flow of the shredding apparatus 10 by a flowchart. In the operation flow illustrated in FIG. 8, the optical sensor 27 executes the height detection operation during shredding operation by the shredding unit 21. The weight sensor 29 does not execute the weight detection operation during the shredding operation by the shredding unit 21. After the shredding unit 21 has ended the shredding operation, the weight sensor 29 executes the weight detection operation. After the shredding unit 21 has ended the shredding operation, the optical sensor 27 stops the height detection operation and does not execute the height detection operation. The operation flow corresponds to one example of the control method.

The shredding apparatus 10 accepts power input operation in a step S201. A user executes input operation to a power button included in the operation buttons 19. When the user has executed the input operation to the power button, the shredding apparatus 10 accepts the power input operation. The shredding apparatus 10 is in the state in which the shredding operation by the shredding unit 21 can be executed.

After accepting the power input operation, the shredding apparatus 10 drives the optical sensor 27 in a step S203. The shredding apparatus 10 does not drive the weight sensor 29. The operation control section 41 causes execution of the height detection operation by the optical sensor 27. The optical sensor 27 starts detection of the bulk height of paper pieces housed in the housing box 23.

After driving the optical sensor 27, the shredding apparatus 10 shreds paper by the shredding unit 21 in a step S205. When the user charges the paper from the paper feed port 15, the shredding unit 21 shreds the paper. The shredding unit 21 discharges paper pieces generated by shredding the paper from the shredding unit opening 21a. The paper pieces discharged are housed in the housing box 23. The optical sensor 27 detects the bulk height of the paper pieces housed in the housing box 23. The optical sensor 27 outputs the height detection data.

When the paper is being shredded by the shredding unit 21, the shredding apparatus 10 detects whether or not the housing box 23 is full in a step S207. The operation control section 41 detects whether or not the housing box 23 is full based on the height detection data output from the optical sensor 27. When the operation control section 41 determines that the housing box 23 is full, the shredding apparatus 10 advances to a step $209 (step S207: YES). When the operation control section 41 determines that the housing box 23 is not full, the shredding apparatus 10 advances to a step S211 (step S207: NO).

In the shredding apparatus 10, the operation control section 41 prohibits the shredding operation by the shredding unit 21 in the step S209. The shredding apparatus 10 stops the shredding operation in response to the prohibition from the operation control section 41. Furthermore, concurrently with this, the shredding apparatus 10 informs the user that the housing box 23 is full, and prompts the user not to charge paper any more and to take out the housing box 23 and empty the content thereof. The display control section 43 transmits display data indicating that the housing box 23 is full to the display unit 17. The display control section 17 executes, based on the display data, display indicating that the housing box 23 is full.

The shredding apparatus 10 stops the shredding unit 21 in the step S211. When the supply of paper to the paper feed port 15 has stopped, the shredding apparatus 10 ends the shredding operation. The operation control section 41 stops the shredding unit 21. The operation control section 41 stops the leveling component 25 simultaneously with the shredding unit 21. The operation control section 41 may stop the leveling component 25 after the elapse of a predetermined time after stopping the shredding unit 21.

After the shredding unit 21 has stopped, the shredding apparatus 10 drives the weight sensor 29 in a step S213. The operation control section 41 causes execution of the weight detection operation by the weight sensor 29. The weight sensor 29 starts detection of the weight of the paper pieces housed in the housing box 23. In the state in which the shredding unit 21 is stopped, the weight sensor 29 detects the weight of the paper pieces housed in the housing box 23. The weight sensor 29 can detect the weight of the paper pieces without being affected by apparatus vibrations caused by driving of the shredding unit 21 and the leveling component 25.

After driving the weight sensor 29, the shredding apparatus 10 detects whether or not the housing box 23 is full in a step S215. The operation control section 41 detects whether or not the housing box 23 is full based on the weight detection data output from the weight sensor 29. When the operation control section 41 determines that the housing box 23 is full, the shredding apparatus 10 advances to the step S209 (step S215: YES). When the operation control section 41 determines that the housing box 23 is not full, the shredding apparatus 10 ends the operation (step S215: NO). The operation control section 41 stops the driving of the weight sensor 29.

The shredding apparatus 10 gives a notification that the housing box 23 is full in the step S209. The display control section 43 transmits display data indicating that the housing box 23 is full to the display unit 17. The display control section 17 executes, based on the display data, display indicating that the housing box 23 is full. The shredding apparatus 10 may transmit the weight of the paper pieces housed in the housing box 23 to an external apparatus through the communication unit 60. The shredding apparatus 10 continues the display indicating that the housing box 23 is full until being powered off by operation to the power button by the user.

What is claimed is:

1. A shredder comprising:
a shredding section that shreds paper into paper pieces;
a housing section that houses the paper pieces;
a bulk height sensor that detects bulk height of the paper pieces housed in the housing section;
a weight sensor that detects weight of the paper pieces housed in the housing section; and
a processor that prohibits shredding by the shredding section in response to indicating fullness of the housing section by either the bulk height detected or the weight detected.
